(19) United States
(12) Patent Application Publication
(10) Pub. No.: US 2023/0330827 A1
(43) Pub. Date: Oct. 19, 2023

(54) Multipurpose Hand Tool

(71) Applicant: Milwaukee Electric Tool Corporation, Brookfield, WI (US)

(72) Inventors: Thomas J. Schneider, Milwaukee, WI (US); Scott M. Hangartner, Richfield, WI (US)

(21) Appl. No.: 18/308,403

(22) Filed: Apr. 27, 2023

Related U.S. Application Data
(63) Continuation of application No. PCT/US2023/018617, filed on Apr. 14, 2023.
(60) Provisional application No. 63/331,358, filed on Apr. 15, 2022.

(51) Int. Cl. B25F 1/04; B25F 1/00

(52) U.S. Cl. CPC B25F 1/04; B25F 1/003

(57) ABSTRACT

A hand tool, such as a multi-tool including pivotable handles is shown. The multi-tool includes a first and second handle, a first and second jaw portion, coupled to the first and second handle, and a plurality of tool components. The multi-tool further includes a locking mechanism that includes an engagement member, a pin, and a biasing element. When the first or second handle is in a locked position, the biasing element applies a force pushing the pin into engagement with the engagement member to secure the first or second handle. When the first or second handle is in an unlocked position, the pin is movable along the engagement member such that the first or second handle is pivotable. In a specific embodiment, the multi-tool including a pre-deployment mechanism configured to deploy the tool component at various angles thereby improving access and opening of the tool components.

### CROSS-REFERENCE TO RELATED PATENT APPLICATION

The present application is a continuation of International Application No. PCT/US2023/018617, filed Apr. 14, 2023, which claims the benefit of and priority to U.S. Provisional Application No. 63/331,358 filed on Apr. 15, 2022, which are incorporated herein by reference in their entireties.

### BACKGROUND OF THE INVENTION

The present invention relates generally to the field of tools. The present invention relates specifically to a hand tool, such as a multipurpose tool that includes a deployment or opening mechanism configured to open or splay individual tool components at various angles to improve ease of opening and/or accessing the tool. The present invention relates specifically to a hand tool, such as a multipurpose tool that includes a handle pivoting and locking feature.

### SUMMARY OF THE INVENTION

One embodiment of the invention relates to a multipurpose tool. The multipurpose tool includes a head with a first jaw and a second jaw. The multipurpose tool includes a first handle and a second handle. The first handle includes a first body and is coupled to the first jaw. The second handle includes a second body and is coupled to the second jaw. A plurality of rotatable tool components are stored within the first body of the first handle and the second body of the second handle. The multipurpose tool further includes a locking mechanism configured to secure the first handle with respect to the head. The locking mechanism includes an engagement member coupled to the first jaw and including a projection and a pin extending toward the head. The pin includes a first end and a second end opposing the first end. The locking mechanism further includes a biasing element that engages the pin, biasing the first end of the pin toward the engagement member. The first handle is rotatable about a pivot axis between a first locked position in which the first jaw extends from the first handle and a second locked position in which the first jaw is positioned within the first body.

Another embodiment of the invention relates to a hand tool. The hand tool includes a head with a first jaw and a second jaw. The hand tool includes a first handle and a second handle. The first handle includes a first body and is coupled to the first jaw. The second handle includes a second body and is coupled to the second jaw. A plurality of rotatable tool components are positioned within the first body of the first handle and the second body of the second handle. The hand tool further includes a locking mechanism. The locking mechanism includes an engagement member coupled to at least one of the first jaw and the second jaw. The engagement member includes a projection. The locking mechanism further includes a pin extending toward the head and a biasing element that engages the pin, biasing the pin toward the engagement member. At least one of the first handle and the second handle is pivotable about a pivot axis between a locked position and an unlocked position. When the at least one of the first handle and the second handle is in the locked position, the biasing element applies a locking force pushing the pin into engagement with the projection of the engagement member to resist movement of the at least one of the first handle and the second handle with respect to the head. When the at least one of the first handle and the second handle is in the unlocked position, the pin is moveable along an outer surface of the engagement member such that the at least one of the first handle and the second handle is pivotable.

Another embodiment of the invention relates to a multipurpose tool. The multipurpose tool includes a pliers head with a first jaw and a second jaw. The multipurpose tool includes a rotatable first handle and a rotatable second handle. The first handle includes a first body and is coupled to the first jaw. The second handle includes a second body and is coupled to the second jaw. A plurality of rotatably mounted tool components are positioned within the first body of the first handle and the second body of the second handle. The multipurpose tool further includes a locking mechanism configured to secure the first handle with respect to the pliers head. The locking mechanism includes an engagement member coupled to the first jaw and including a first projection and a second projection. The locking mechanism further includes a pivot axis extending through the engagement member, a pin extending toward the pliers head, and a biasing element that engages the pin, biasing the pin toward the engagement member. When the biasing element applies a locking force on the pin, the pin moves into engagement with the engagement member. The first projection resists movement of the pin such that the first handle is secured in an extended position. When the engagement member applies a force greater than the locking force on the pin, the biasing element is compressed such that the pin moves past the first projection into an unlocked position in which the pin is freely rotatable about an outer surface of the engagement member.

In a specific embodiment, the plurality of tool components each include a ramp located on a shank of the tool component. Each ramp includes an angle different from the angle of the ramp of the other tool components. The hand tool further includes a pre-deployment assembly configured to engage with the ramps of the tool components. When a user moves the pre-deployment assembly against the respective ramps of each tool component the tool components will be at least partially opened and extended at various angles. In a specific embodiment, when a user moves the pre-deployment assembly toward the first and second jaw portions, the pre-deployment assembly engages with the respective ramps of each tool component such that the tool components will be at least partially opened and extended at various angles.

The accompanying drawings are included to provide further understanding and are incorporated in and constitute a part of this specification. The drawings illustrate one or more embodiments and, together with the description, serve to explain principles and operation of the various embodiments.

### BRIEF DESCRIPTION OF THE DRAWINGS

This application will become more fully understood from the following detailed description, taken in conjunction with the accompanying figures, wherein like reference numerals refer to like elements in which:

FIG. 1 is a top perspective view of a multi-tool, according to an exemplary embodiment.

FIG. 2 is a bottom perspective view of the multi-tool of FIG. 1, according to an exemplary embodiment.

FIG. 3 is a cross-sectional view of the multi-tool of FIG. 2, according to an exemplary embodiment.

FIG. 4 is a left perspective view of the multi-tool of FIG. 1, according to an exemplary embodiment.

FIG. 5 is a partially exploded view of a handle of the multi-tool of FIG. 1, according to an exemplary embodiment.

FIG. 6 is a detailed perspective view of the handle of FIG. 5 with a body of the handle and the deployment slider removed, according to an exemplary embodiment.

FIG. 7 is a perspective view of another handle of the multi-tool of FIG. 1 with the body of the handle removed, according to an exemplary embodiment.

FIG. 8 is a detailed perspective view of the handle of FIG. 7 with the deployment slider removed, according to an exemplary embodiment.

FIG. 9 is a top perspective view of a multi-tool in a closed position, according to another exemplary embodiment.

FIG. 10 is a bottom perspective view of the multi-tool of FIG. 9 in a closed position, according to an exemplary embodiment.

FIG. 11 is a top view of the multi-tool of FIG. 9, according to an exemplary embodiment.

FIG. 12 is a top view of the multi-tool of FIG. 9 with a portion of the handle removed, according to an exemplary embodiment.

FIG. 13 is a perspective view of the multi-tool of FIG. 9 in an open position, according an exemplary embodiment.

FIG. 14 is a cross-sectional view of the multi-tool of FIG. 9 taken along line 14-14 of FIG. 13, according to an exemplary embodiment.

FIG. 15 is a top perspective view of the multi-tool of FIG. 9 in the open position with the portion of the handle removed, according an exemplary embodiment.

FIG. 16 is a bottom perspective view of the multi-tool of FIG. 9 in the open position with the portion of the handle removed, according an exemplary embodiment.

FIG. 17 is a detailed perspective view of a handle of the multi-tool of FIG. 9 moving into an intermediate position, according to an exemplary embodiment.

FIG. 18 is a detailed perspective view the handle of the multi-tool of FIG. 9 in the intermediate position, according to an exemplary embodiment.

FIG. 19 is a perspective view of a multi-tool in a closed position, according to another exemplary embodiment.

FIG. 20 is a top perspective view of the multi-tool of FIG. 19 in a fully closed position with a portion of the handle removed, according to an exemplary embodiment.

FIG. 21 is a bottom perspective view of the multi-tool of FIG. 19, according to an exemplary embodiment.

FIG. 22 is a top perspective view of the multi-tool of FIG. 19 in the open position, according to an exemplary embodiment.

FIG. 23 is a bottom perspective view of the multi-tool of FIG. 19 in the open position, according to an exemplary embodiment.

FIG. 24 is a top perspective view of the multi-tool of FIG. 19 in a fully open position with a portion of the handle removed, according to an exemplary embodiment.

FIG. 25 is a top perspective view of the multi-tool of FIG. 19 in a partially open position with a portion of the handle removed, according to an exemplary embodiment.

### DETAILED DESCRIPTION

Referring generally to the figures, various embodiments of a hand tool, specifically a multipurpose or multi-tool are shown. Various embodiment of the hand tool discussed herein include an innovative pre-deployment feature for the various tool components positioned and/or stored within each handle of the handle tool. The pre-deployment feature is designed to at least partially open or deploy the tool components so that a user can more easily open and/or access the tool components from the closed (e.g., stored) position. Specifically, the pre-deployment assembly partially opens or splays the tool components stored within one or more of the handles at different angles such that a user can easily choose a specific tool component for use. In contrast to the multi-tool discussed herein, many multi-tools may be difficult to open because their compact storage of numerous tool components does not allow a user to quickly separate a single, desired tool component for opening. Applicant believes the pre-deployment assembly discussed herein allows a user to more efficiently choose and open one or more desired tool components from the multi-tool.

Various embodiment of the hand tool discussed herein include an innovative handle pivoting and locking feature. Applicant believes the handle pivoting and locking feature discussed herein prevents accidental movement of the handles from a locked, extended position or a storage position in which the tool head is stored within the handles. Various embodiments, of the locking feature discussed herein include an engagement member coupled to at least one of the jaws of the multi-tool, a pin, and a biasing element. The biasing element pushes the pin into engagement with the engagement member which provides resistance to rotation of the handles.

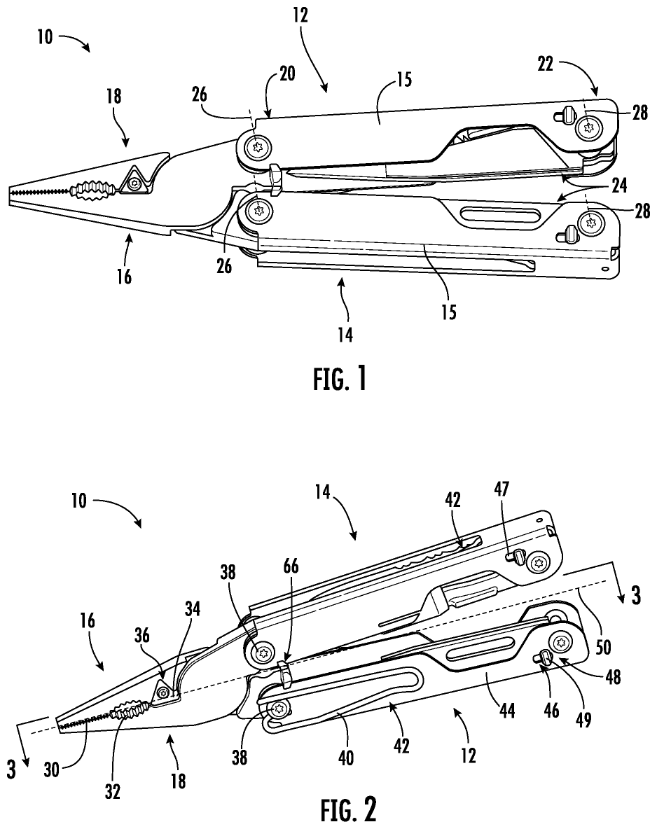

Referring to FIGS. 1-2, various aspects of a hand tool, shown as a multipurpose or multi-tool 10, are shown. In general, multi-tool 10 includes a first handle 12 and a second handle 14. First handle 12 is coupled to a first jaw portion 16 and second handle 14 is coupled to a second jaw portion 18. Each handle 12, 14 includes a body 15 with a proximal or jaw end 20 and a distal or handle end 22 that opposes jaw end 20. At jaw end 20 each handle 12, 14 is coupled to first jaw portion 16 and second jaw portion 18 respectively by a fastener, shown as a screw 38. Each handle 12, 14 is moveable and/or rotatable about a handle pivot axis 26 such that a distance between first handle 12 and second handle 14 can be increased or decreased.

A plurality of tool components 24 are positioned and/or stored within body 15 of first and second handles 12, 14. The plurality of tool components 24 are coupled to first and second handles 12, 14 respectively at handle end 22 and rotatable about a tool component axis of rotation 28. In a specific embodiment, multi-tool includes a plier tool head. In other embodiments the multi-tool may include a different type of tool head (e.g., cutting head, clamp, etc.).

Referring to FIG. 2, multi-tool further includes a longitudinal axis 50. First jaw portion 16 and second jaw portion 18 each include a gripping surface 30 extending along longitudinal axis 50. The gripping surface 30 of the first jaw portion 16 faces the gripping surface 30 of the second jaw portion 18. A plurality of apertures 32 are positioned on first jaw portion 16 and second jaw portion 18 along longitudinal axis 50 between gripping surfaces 30 and first and second handles 12, 14 respectively. Apertures 32 extend through the first and second jaw portions 16, 18 with first and second jaw portions 16, 18 cooperating to form the plurality of apertures 32 (e.g., approximately one half). The apertures are configured to strip insulation from a wire. In a specific embodiment, the plurality of apertures together form an oval shape (e.g., close together and/or smaller apertures on each end). In other embodiments, the plurality of apertures may have a different configuration (e.g., consistent distance between apertures on first and second jaw portions, etc.).

The multi-tool 10 further includes a wire cutter insert 34 positioned within a wire cutter insert recess 36. In a specific embodiment, both the first and second jaw portion 16, 18 include a wire cutter insert 34 and a wire cutter insert recess 36 on opposing sides of multi-tool 10. In another embodiment, only one of first and second jaw portions 16, 18 includes a wire cutter insert 34 and a wire cutter insert recess 36. In a specific embodiment, the wire cutter insert includes 3 sides. In other embodiments, the wire cutter insert may include a different number of sides (e.g., 4, 5, etc.).

The body 15 of each handle 12, 14 includes a pair of opposing side walls 42 coupled together at least partially by a connecting wall 58 (see e.g., FIG. 3). Each side wall 42 includes an outward facing side surface 44. In a specific embodiment, one side surface 44 includes a clip 40 coupled to the body 15 by screw 38. Clip 40 is configured to attach to a narrow object such as a belt or tool bag. At handle end 22 each side wall 42 includes a slot 46 defined by a continuous edge 47. Slot 46 receives an external knob portion 49 of pre-deployment assembly 48. Pre-deployment assembly 48 will be described in greater detail below.

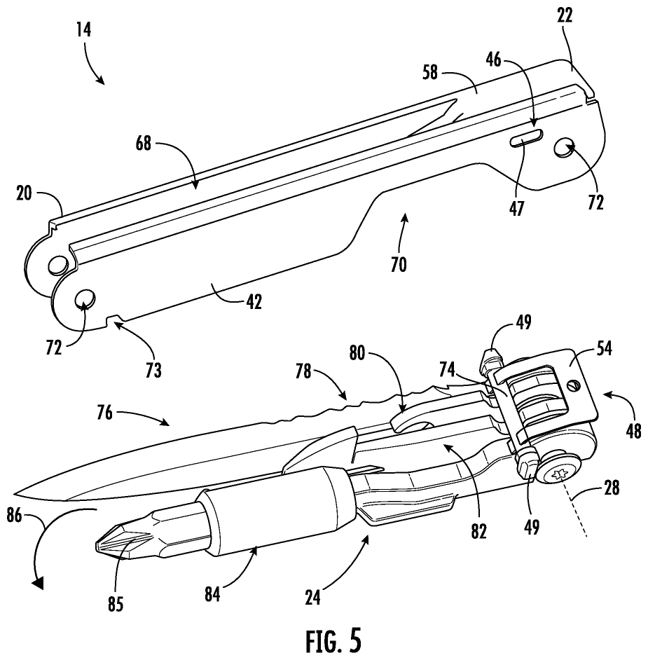

Referring to FIG. 3, a cross-sectional view of FIG. 2 is shown according to an exemplary embodiment. The pre-deployment assembly 48 includes an internal slider 54 positioned within the body 15 of the first and second handle 12, 14. Internal slider 54 is coupled to a connector 74 (see e.g., FIG. 5) that extends between the pair of opposing external knob portions 49 coupled to each end of connector 74. Pre-deployment assembly 48 is moveable within body 15 of each handle 12, 14 in the direction shown by arrow 56, along longitudinal axis 50. When a user grasps and moves the external knob portion 49 within slot 46 toward first and second jaw portion 16, 18, pre-deployment assembly 48 engages with the plurality of tool components 24 to at least partially open or deploy the tool components 24.

As shown in FIG. 3, multi-tool 10 includes a spring mechanism 60 such that multi-tool 10 is spring loaded. Spring mechanism 60 includes a groove 62 is formed by the first and second jaw portions 16, 18 (e.g., approximately one half of groove is formed by each jaw portion). Spring mechanism 60 further includes a spring, shown as compression spring 64. Compression spring 64 is received within groove 62 such that a user can open the first and second jaw portion 16, 18 with reduced effort. FIG. 2 shows locking mechanism 66, that engages with side wall 42 of each handle 12, 14 to lock the first jaw portion 16 and second jaw portion 18 to the handles 12, 14. Specifically, locking mechanism 66 is received within a recess 73 (see e.g., FIG. 5) on the side wall 42 of each handle 12, 14.

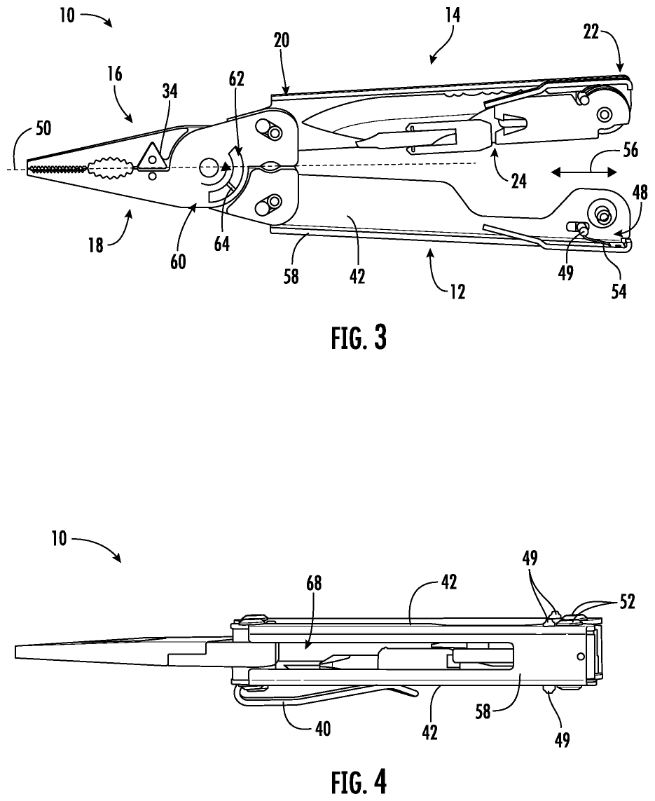

Referring to FIG. 4, a left perspective view of the multi-tool 10 is shown according to an exemplary embodiment. Connecting wall 58 includes an opening 68 extending along longitudinal axis 50. Multi-tool 10 further includes a plurality of fastening components, shown as internally threaded shafts 52. Internally threaded shafts 52 are positioned on one side of first and/or second handles 12, 14 to receive and engage with the plurality of screws 38.

Referring to FIG. 5, a partially exploded view of second handle 14 is shown, according to an exemplary embodiment. First handle 12 is substantially the same as second handle 14 except for the differences discussed herein. As such, the operation of pre-deployment assembly 48 will only be described in terms of second handle 14. Each opposing side wall 42 includes an access recess 70 extending inward (i.e., toward connecting wall 58). Access recess 70 provides improved access to the plurality of tool components 24 stored within second handle 14. Each opposing side wall 42 further includes a fastening bore 72 at both jaw end 20 and handle end 22 of second handle 14 to receive at least a portion of screw 38 and/or internally threaded shaft 52. The screws 38 and/or internally threaded shafts 52 extend along tool component axis of rotation 28 and together define an axle 53 about which the plurality of tool components 24 rotate.

In a specific embodiment, multi-tool 10 and second handle 14 specifically have a plurality of tool components 24 including a knife 76 with a serrated edge portion 78, a bottle opener 80, a pry bar 82, and a fastening tool, shown as a bit driver 84. Knife 76, bottle opener 80, pry bar 82, and bit driver 84 each include a through bore and are coupled to and rotatable about the screw 38 and internally threaded shaft 52 positioned at handle end 22. In other embodiments, the multi-tool may include different tool components and the tool components shown in second handle 14 may instead be positioned within first handle 12. When pre-deployment assembly 48 engages with the plurality of tool components 24 to at least partially open or deploy the tool components 24, the tool components move in the direction shown by arrow 86 (toward longitudinal axis 50) and rotate about tool component axis of rotation 28.

In a specific embodiment, bit driver 84 receives and engages with a tool bit 85, tool bit 85 is configured to engage with a Phillips-head type fastener. In other embodiments, tool bit 85 may be reversible such that the opposing end includes an end configured to engage with a flat head type fastener. In a specific embodiment, tool bit 85 is retained within bit driver 84 magnetically. In other embodiments, tool bit 85 can be retained by another mechanism (e.g., retaining clip, friction, etc.).

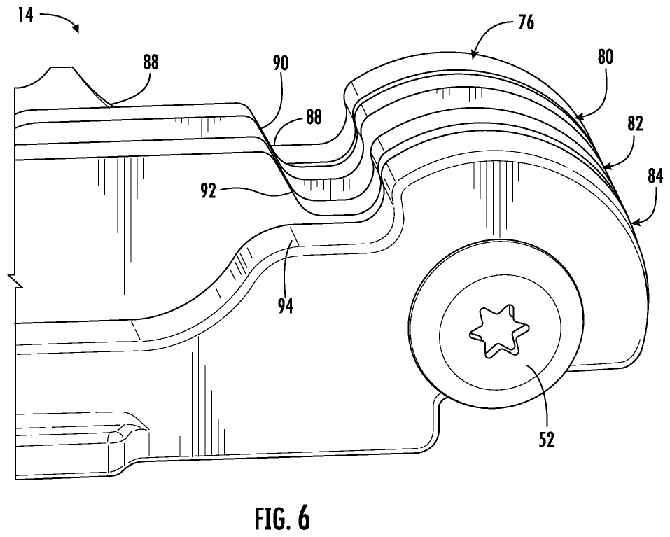

Referring to FIG. 6, a detailed perspective view of the second handle 14 with body 15 and pre-deployment assembly 48 removed is shown, according to an exemplary embodiment. In general, each of the tool components 24 includes a shaft or tang. Each tool component includes an inward facing (e.g., toward pre-deployment assembly 48 and/or connecting wall 58 of second handle 14. Pre-deployment assembly 48 is configured to engage with the ramp on each tool component such that the tool components will begin to open or deploy, allowing a user to more easily choose the desired tool component to open fully.

Knife 76 includes an inward facing, ramp surface 88 and bottle opener 80 includes an inward facing, ramp surface 90. Similarly, pry bar 82 includes an inward facing, ramp surface 92 and bit driver 84 includes an inward facing, ramp surface 94. When a user moves pre-deployment assembly 48 toward jaw end 20 of handle 14, the differences between the inward facing ramp surface (e.g., 88, 90, 92, 94) will cause the tool components 24 to splay or partially open the tool components 24 at various angles. The difference in the angular position of the tool components 24 allows the user to deliberately and efficiently choose the desired tool component, rather than struggling to open the multi-tool because of the compact storage of numerous tool components as seen with conventional multi-tools.

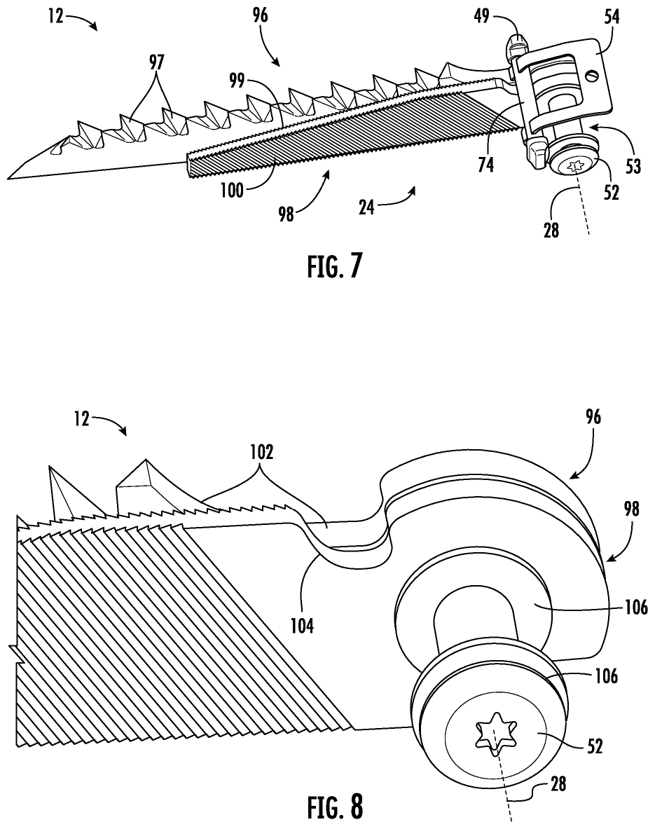

Referring to FIG. 7, a perspective view of the first handle 12 with body 15 removed is shown, according to an exemplary embodiment. In a specific embodiment, multi-tool 10 and first handle 12 specifically have a plurality of tool components 24 including a saw 96 with a plurality of saw teeth 97 and a file 98. File 98 includes a first file surface 99 with a file pattern (e.g., angled ridges extending across the surface) and a second file surface 100 that opposes first file surface 99. In a specific embodiment, second file surface 100 includes a different file pattern than first file surface 99 (e.g., crossed angular pattern, etc.). In other embodiments, the multi-tool may include different tool components and the tool components shown in first handle 12 may instead be positioned within second handle 14.

Referring to FIG. 8, a detailed perspective view of the first handle 12 with body 15 and pre-deployment assembly 48 removed is shown, according to an exemplary embodiment. In a specific embodiment, multi-tool includes one or more washers 106. One or more washers 106 may be used to maintain separation of the plurality of tool components 24. Saw 96 includes an inward facing, ramp surface 102 and file 98 includes an inward facing, ramp surface 104. When a user moves pre-deployment assembly 48 toward jaw end 20 of handle 12, the differences between the inward facing ramp surface (e.g., 102, 104, etc.) will cause the tool components 24 to splay or partially open the tool components 24 at various angles.

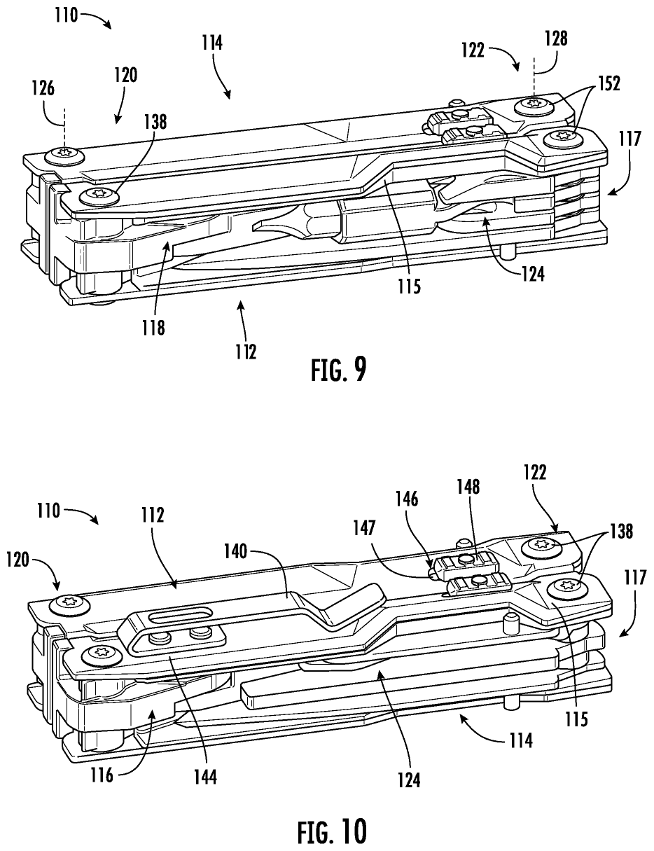

Referring to FIGS. 9-18, various aspects of a hand tool, shown as a multi-tool 110, are shown. Multi-tool 110 is substantially the same as multi-tool 10 except for the differences discussed herein. The pre-deployment assembly 48 can be utilized with multi-tool 110.

Referring to FIGS. 9-12, various aspects of multi-tool 110 in a closed or storage position, are shown. In general, multi-tool 110 includes a first handle 112 and a second handle 114. First handle 112 is coupled to a first jaw or first jaw portion 116 and second handle 114 is coupled to a second jaw or second jaw portion 118. The first jaw portion 116 and second jaw portion 118 together define a tool head.

Each handle 112, 114 includes a body 115 with a proximal or jaw end 120 and a distal or handle end 122 that opposes jaw end 120. At jaw end 120 each handle 112, 114 includes a cavity 117 defined within the body 115. Each handle 112, 114 is moveable and/or rotatable about a handle pivot axis 126 such that a distance between first handle 112 and second handle 114 can be increased or decreased. Additionally, each handle 112, 114 is pivotable into a closed or storage position in which the head of the tool is stored within the body 115 of first handle 112 and/or second handle 114 and specifically within cavity 117.

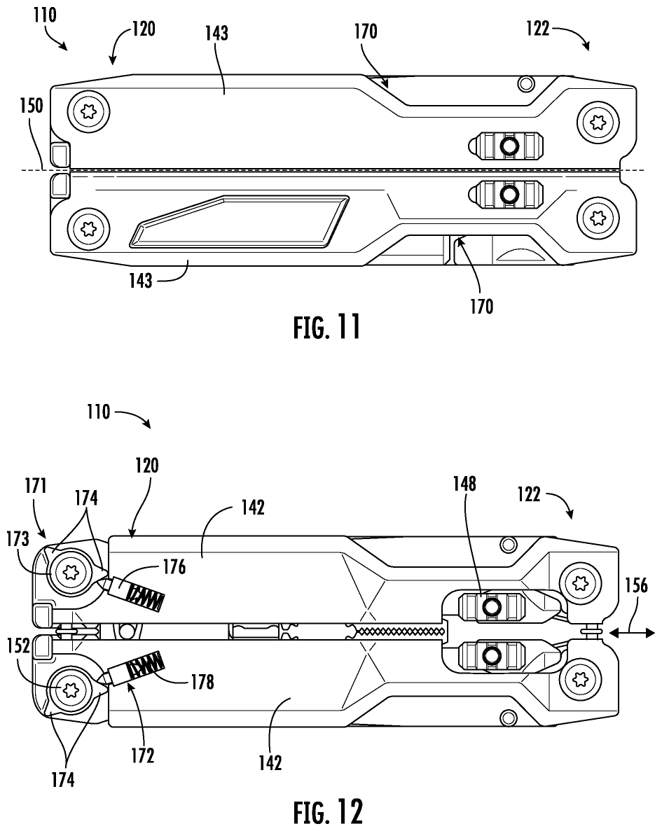

As shown in FIGS. 11-12, a handle cover 143 is coupled to each of the opposing side walls 142 of first and second handles 112, 114. In FIG. 12, handle cover 143 has been removed making a locking mechanism 171 visible. Locking mechanism 171 is configured to secure first handle 112 and/or second handle 114 with respect to the tool head (i.e., resists rotation and/or movement). Locking mechanism 171 includes an engagement member 173, a pin 176, and a biasing element, shown as spring 178. Engagement member 173 is coupled to first jaw portion 116 and/or second jaw portion 118. Specifically, engagement member 173 is coupled to an outer surface of first jaw portion 116 and/or second jaw portion 118. In a specific embodiment, an engagement member 173 is coupled to each opposing outer surface of first jaw portion 116 and second jaw portion 118 such that there are four engagement members 173. In various specific embodiments, there may be a different number of engagement members 173 (e.g., 1, 2, etc.).

Engagement member 173 includes a protrusion or projection 174 that extends outward from engagement member 173 along side wall 142. In various specific embodiments, engagement member 173 includes a pair of projections 174 or a first and second projection 174. In such an embodiment, the second projection 174 extends outward from the engagement member 173 at a position angularly spaced apart from first projection 174 about pivot axis 126. Pivot axis 126 extends through engagement member 173. In a specific embodiment, pivot axis 126 is a central axis of engagement member 173. At least a portion of screw 138 and/or internally threaded shaft 152 is received within engagement member 173. The screws 138 and/or internally threaded shafts 152 extend along pivot axis 126.

When locking mechanism 171 is assembled, pin 176 extends toward the tool head and/or first jaw portion 116 and/or second jaw portion 118. Pin 176 includes a first end and a second end opposing the first end. Spring 178 engages the second end of pin 176, biasing the first end of pin 176 toward engagement member 173. Opposing side wall 142 includes an outward facing surface (i.e., direction facing away from cavity 117) with a recess 172 defined in the outward facing surface. Recess 172 extends at an angle relative to a longitudinal axis of opposing side wall 142. Pin 176 and spring 178 are positioned within recess 172. Spring 178 and pin 176 similarly extend at an angle relative to the longitudinal axis of the opposing side wall 142. In various specific embodiments, the number of recesses 172 defined in opposing side walls 142 is the same as the number of engagement members 173.

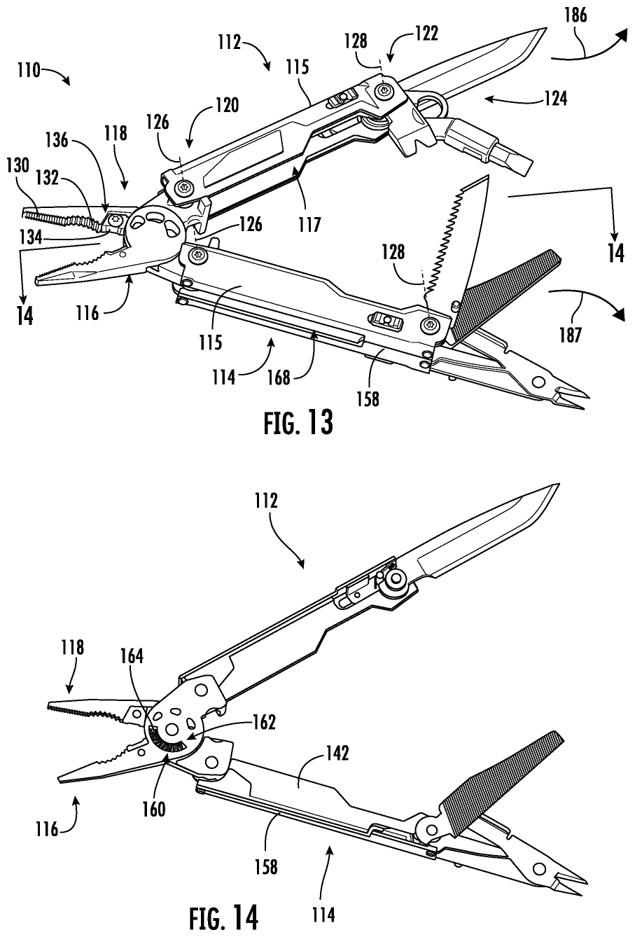

Referring to FIGS. 13-16, perspective views of multi-tool 110 are shown, with tool components 124 in extended or open positions. The plurality of tool components 124 are positioned and/or stored within body 115 of first and second handles 112, 114 (see e.g., FIGS. 9-12). The plurality of tool components 124 are coupled to first and second handles 112, 114 respectively at handle end 122 and rotatable about a tool component axis of rotation 128. In the illustrated embodiment, multi-tool 110 includes a plier tool head. In other embodiments the multi-tool 110 may include a different type of tool head (e.g., cutting head, clamp, etc.). In various specific embodiments, the plurality of tool components 124 include a knife, bottle opener, pry bar, bit driver, file, and scissors. In various embodiments, a different number or type of tool components may be used.

The multi-tool 110 further includes a wire cutter insert 134 positioned within a wire cutter insert recess 136. In a specific embodiment, the wire cutter insert includes 4 sides. In other embodiments, the wire cutter insert may include a different number of sides (e.g., 3, 5, etc.). FIG. 14 shows a cross-sectional view of the multi-tool 110 taken along line 14-14 of FIG. 13, according to an exemplary embodiment. Multi-tool 110 includes a spring mechanism 160 such that multi-tool 110 is spring loaded. Spring mechanism 160 includes a groove 162 that is formed by the first and second jaw portions 116, 118 (e.g., approximately one half of groove is formed by each jaw portion) and a spring, shown as compression spring 164. Compression spring 164 is received within groove 162 such that a user can open the first and second jaw portions 116, 118 with reduced effort.

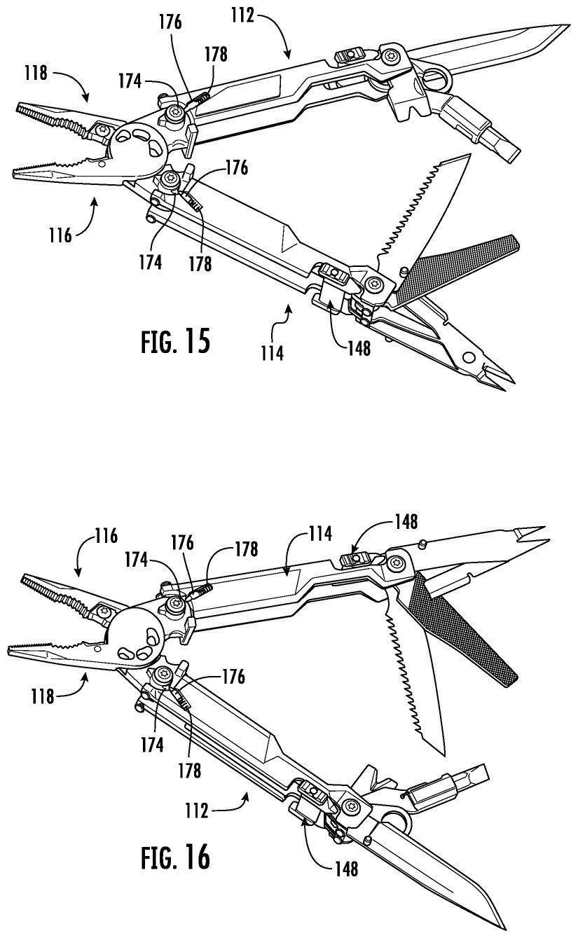

First handle 112 is shown in a first locked position in FIG. 16, with first handle 112 extended from first jaw portion 116. In such a position, spring 178 pushes the first end of pin 176 into engagement with engagement member 173 and specifically projection 174 such that first handle 112 is secured or resists rotation relative to the tool head. In other words, spring 178 applies a locking force on pin 176, moving pin 176 into engagement member 173. Projection 174 resists movement of pin 176 such that the first handle is secured (i.e., resists rotation, movement) in the extended position.

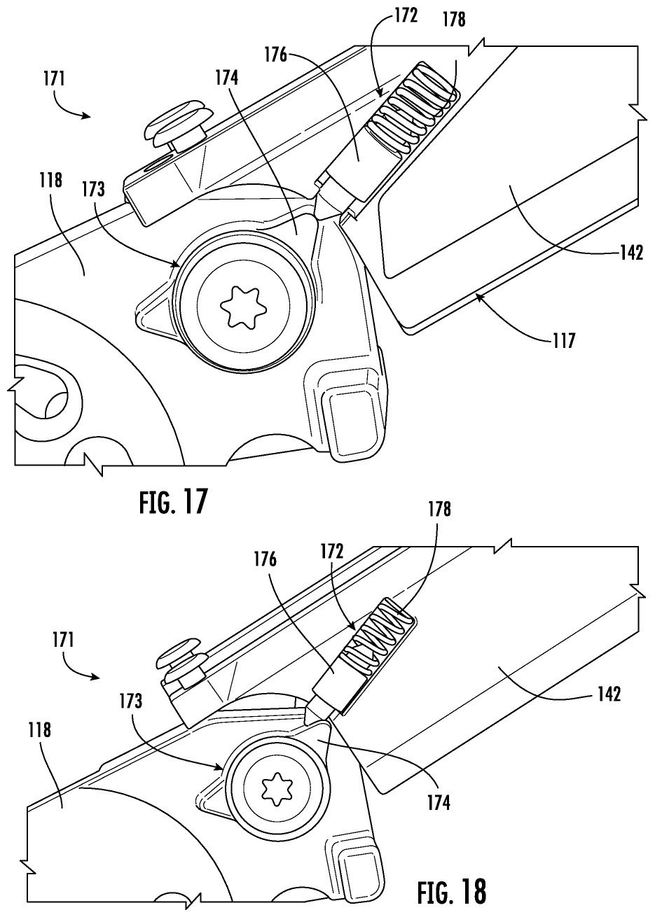

Referring to FIGS. 17-18, details of the pivoting of first handle 112 and locking mechanism 171 are shown, according to an exemplary embodiment. The pivoting of second handle 114 is substantially the same as first handle 112 and as such will not be discussed separately. When the engagement member 173 and specifically projection 174 applies a force on pin 176 greater than the locking force, spring 178 is compressed such that pin 176 moves past projection 174. Each projection 174 includes a ramped or sloped shape. In other words, projection 174 includes a first angled outer surface extending outward from engagement member 173 towards a tip of projection 174 and a second angled outer surface extending between the top of projection 174 and engagement member 173. In various specific embodiments, the tip portion of projection 174 is rounded. The shape of the projection 174 and relative positioning of the recess 172, spring 178 and pin 176 provide the desired force at the desired position during the opening and closing of the handles 112, 114.

As shown in FIG. 17, when first handle 112 is moving out of the first locked position, pin 176 is in an orientation aligned with projection 174 of engagement member 173. When projection 174 engages the first end of pin 176, spring 178 is compressed such that the first handle 112 is moveable past projection 174, allowing rotation of first handle 112.

Referring to FIG. 18, a detailed perspective view of the locking mechanism in an intermediate or unlocked position is shown, according to an exemplary embodiment. In the unlocked position, pin 176 is freely rotatable about an outer surface of engagement member 173. When first handle 112 is in the unlocked position, pin 176 is positioned along the outer surface of the engagement member 173 between the first and second projections 174.

Similar to moving from the first locked position to the unlocked position, when the first handle 112 is in the unlocked position and rotated toward the tool head and a force greater than the locking force is applied to pin 176, pin 176 moves past the second projection 174 such that first handle 112 is secured (i.e., resists rotation) in the storage or second locked position (see e.g., FIG. 12). When first handle 112 is in the storage position, spring 178 applies the locking force on pin 176, moving pin 176 into engagement member 173. The second projection 174 resists movement of pin 176 such that the first handle is secured (i.e., resists rotation) in the storage position with the tool head folded into the body 115 and/or cavity 117. In other words, first handle 112 is rotatable about pivot axis 126 between the first locked position (see e.g., FIG. 16) in which the first handle 112 is extended from first jaw portion 116 and the second locked position in which the first jaw is positioned within the first body 115.

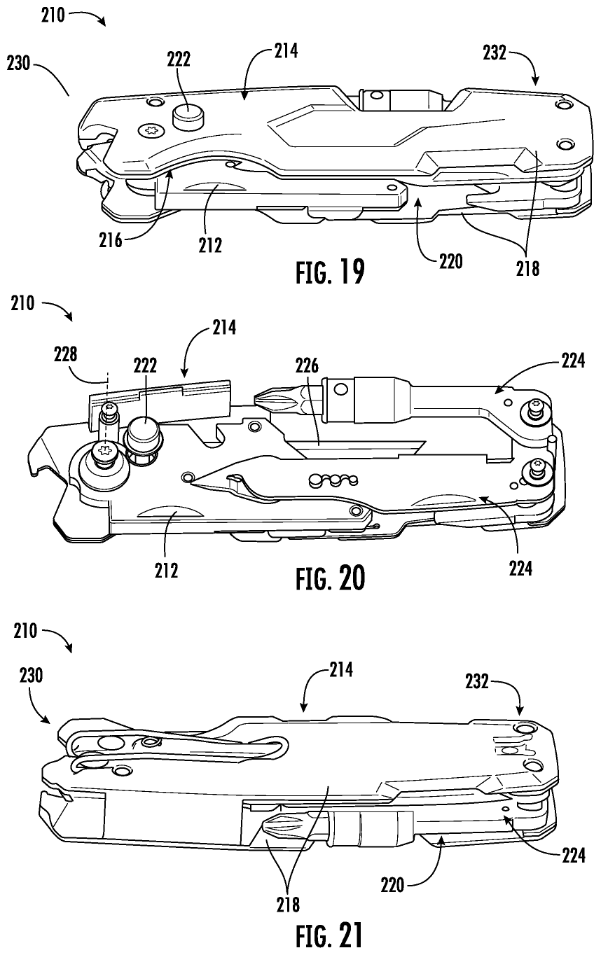

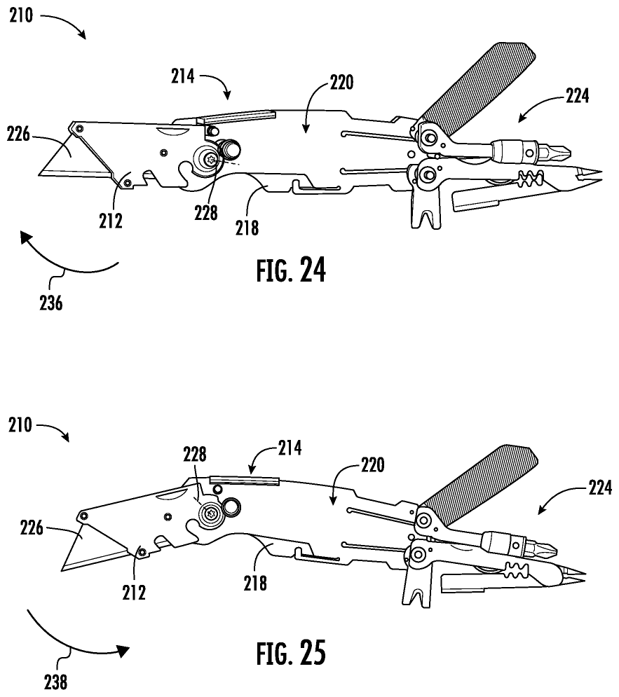

Referring to FIGS. 19-25, various aspects of a hand tool, shown as a multi-tool 210, are shown. Multi-tool 210 is substantially the same as multi-tools 10, 110 except for the differences discussed herein. The pre-deployment assembly 48 of multi-tool 10 can be utilized with multi-tool 210.

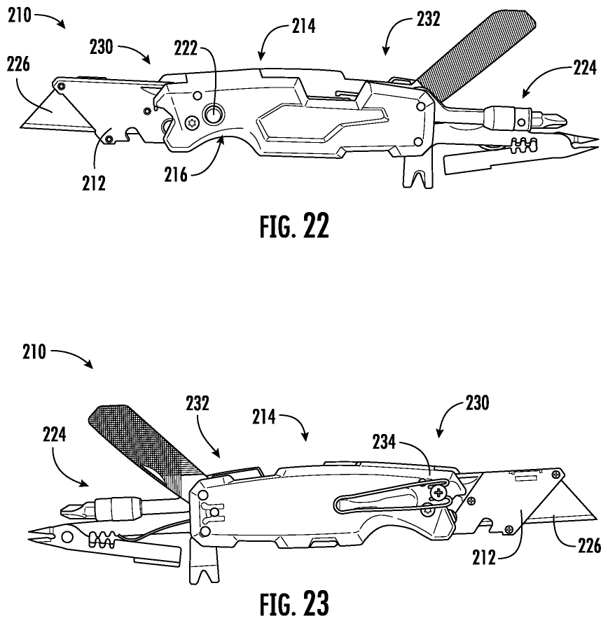

In general, multi-tool 210 includes a handle or body 214, a blade holder 212, and a blade 226 coupled to the blade holder 212. The blade holder 212 is pivotally coupled to the body 214 and movable (pivoted) between a folded, or retracted, position (see FIGS. 19-21), in which at least the cutting edge of the blade 226 is received within the body 214, and an extended position (FIGS. 22-25), in which the blade holder 212 and the blade 226 extend from a front end 230 of the body 214. A rear end 232 opposes front end 230 of body 214. Blade holder 212 is moveable about pivot axis 228. When blade holder is moved in a first or clockwise direction shown by arrow 236, blade holder 212 and blade 2226 move toward a cutting position. When blade holder is moved in a second, counterclockwise direction, shown by arrow 238, blade holder 212 and blade 226 move towards the retracted position.

The multi-tool 210 further includes a lock member 222 operable to selectively lock and unlock the blade holder 212 from either or both the extended position and the retracted position. In the illustrated embodiment, the lock member 222 is configured as a push button that is engageable with a rear portion of the blade holder 212 to retain the blade holder 212 in the extended and/or retracted position. In other embodiments, other locking means may be used.

Body 214 includes a pair of opposing side walls 218 that at least partially define a cavity 220. Body 214 further includes an access recess 216 extending inward (i.e., toward lock member 222). Access recess 216 provides improved access to the plurality of tool components 224 stored within body 214 and specifically within cavity 220. In a specific embodiment, a clip 234 is coupled to the body 214 and specifically to one of the opposing side walls 218.

Referring to FIGS. 22-25, multi-tool 210 is shown with tool components 224 in extended or open positions. The plurality of tool components 224 are positioned and/or stored within body 214. The plurality of tool components 224 are coupled at the rear end 232 of body 214 and rotatable about a tool component axis of rotation. In the illustrated embodiment, multi-tool 210 includes a knife tool head. In other embodiments the multi-tool 210 may include a different type of tool head (e.g., cutting head, clamp, etc.). In various specific embodiments, the plurality of tool components 224 include a bottle opener, pry bar, bit driver, file, and scissors.

It should be understood that the figures illustrate the exemplary embodiments in detail, and it should be understood that the present application is not limited to the details or methodology set forth in the description or illustrated in the figures. It should also be understood that the terminology is for the purpose of description only and should not be regarded as limiting.

Further modifications and alternative embodiments of various aspects of the invention will be apparent to those skilled in the art in view of this description. Accordingly, this description is to be construed as illustrative only. The construction and arrangements, shown in the various exemplary embodiments, are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter described herein. Some elements shown as integrally formed may be constructed of multiple parts or elements, the position of elements may be reversed or otherwise varied, and the nature or number of discrete elements or positions may be altered or varied. The order or sequence of any process, logical algorithm, or method steps may be varied or re-sequenced according to alternative embodiments. Other substitutions, modifications, changes and omissions may also be made in the design, operating conditions and arrangement of the various exemplary embodiments without departing from the scope of the present invention.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that any particular order be inferred. In addition, as used herein, the article “a” is intended to include one or more component or element, and is not intended to be construed as meaning only one. As used herein, “rigidly coupled” refers to two components being coupled in a manner such that the components move together in a fixed positional relationship when acted upon by a force.

For purposes of this disclosure, the term “coupled” means the joining of two components directly or indirectly to one another. Such joining may be stationary in nature or movable in nature. Such joining may be achieved with the two members and any additional intermediate members being integrally formed as a single unitary body with one another or with the two members or the two members and any additional member being attached to one another. Such joining may be permanent in nature or alternatively may be removable or releasable in nature.

While the current application recites particular combinations of features in the claims appended hereto, various embodiments of the invention relate to any combination of any of the features described herein whether or not such combination is currently claimed, and any such combination of features may be claimed in this or future applications. Any of the features, elements, or components of any of the exemplary embodiments discussed above may be used alone or in combination with any of the features, elements, or components of any of the other embodiments discussed above.

In various exemplary embodiments, the relative dimensions, including angles, lengths and radii, as shown in the Figures are to scale. Actual measurements of the Figures will disclose relative dimensions, angles and proportions of the various exemplary embodiments. Various exemplary embodiments extend to various ranges around the absolute and relative dimensions, angles and proportions that may be determined from the Figures. Various exemplary embodiments include any combination of one or more relative dimensions or angles that may be determined from the Figures. Further, actual dimensions not expressly set out in this description can be determined by using the ratios of dimensions measured in the Figures in combination with the express dimensions set out in this description.

What is claimed:

1. A multipurpose tool comprising:
a head comprising:
a first jaw; and
a second jaw;
a first handle, the first handle including a first body and coupled to the first jaw;
a second handle, the second handle including a second body coupled to the second jaw;
a plurality of rotatable tool components stored within the first body of the first handle and the second body of the second handle; and
a locking mechanism configured to secure the first handle with respect to the head, the locking mechanism comprising:
an engagement member coupled to the first jaw and including a projection;
a pin extending toward the head, the pin comprising:
a first end; and
a second end opposing the first end; and
a biasing element that engages the pin, biasing the first end of the pin toward the engagement member;
wherein the first handle is rotatable about a pivot axis between a first locked position in which the first jaw extends from the first handle, and a second locked position in which the first jaw is positioned within the first body.

2. The multipurpose tool of claim 1, wherein the biasing element pushes the first end of the pin into engagement with the projection, such that the first handle resists rotation relative to the head.

3. The multipurpose tool of claim 1, the first body further comprising:
a side wall having an outward facing surface; and
a recess defined in the outward facing surface of the side wall;
wherein the pin and the biasing element are positioned within the recess of the first body.

4. The multipurpose tool of claim 3, wherein, when the pin is in an orientation aligned with the projection of the engagement member, the projection engages the first end of the pin compressing the biasing element such that the first handle is movable past the projection of the engagement member.

5. The multipurpose tool of claim 1, the locking mechanism further comprising:
a second engagement member coupled to a side of the first jaw opposing the engagement member;
a second pin extending toward the head, the pin comprising:
a first end; and
a second end opposing the first end; and
a second biasing element that engages the second end of the pin, biasing the first end of the second pin toward the second engagement member.

6. The multipurpose tool of claim 1, further comprising:
a second locking mechanism configured to secure the second handle with respect to the head, the second locking mechanism comprising:
an engagement member coupled to the second jaw and including a projection;
a pin extending toward the head, the pin comprising:
a first end; and
a second end opposing the first end; and
a biasing element that engages the second end of the pin, biasing the first end of the pin toward the engagement member;
wherein the second handle is rotatable about a pivot axis between a first locked position in which the second jaw extends from the second handle and a second locked position in which the second jaw is positioned within the second body.

7. The multipurpose tool of claim 1, wherein the pivot axis is a central axis of the engagement member.

8. The multipurpose tool of claim 1, wherein the engagement member is coupled to an outer surface of the first jaw.

9. A hand tool comprising:
a head comprising:
a first jaw; and
a second jaw;
a first handle, the first handle including a first body and coupled to the first jaw;
a second handle, the second handle including a second body coupled to the second jaw;
a plurality of rotatable tool components positioned within the first body of the first handle and the second body of the second handle; and
a locking mechanism comprising:
an engagement member coupled to at least one of the first jaw and the second jaw, the engagement member including a projection;
a pin extending toward the head; and
a biasing element that engages the pin, biasing the pin toward the engagement member;
wherein at least one of the first handle and the second handle is pivotable about a pivot axis between a locked position and an unlocked position;
wherein, when the at least one of the first handle and the second handle is in the locked position, the biasing element applies a locking force pushing the pin into engagement with the projection of the engagement member to resist movement of the at least one of the first handle and the second handle with respect to the head; and
wherein, when the at least one of the first handle and the second handle is in the unlocked position, the pin is movable along an outer surface of the engagement member such that the at least one of the first handle and the second handle is pivotable.

10. The hand tool of claim 9, wherein, when the projection engages the pin such that the biasing element is compressed, at least one of the first handle and the second handle is rotatable past the projection of the engagement member and moveable into the unlocked position.

11. The hand tool of claim 9, the engagement member further comprising a second projection extending outward from the engagement member at a position angularly spaced apart from the projection about the pivot axis.

12. The hand tool of claim 11, wherein, when the second projection engages the pin such that the biasing element is compressed, at least one of the first handle and the second handle is rotatable past the second projection of the engagement member and moveable into a storage position in which the head is positioned within at least one of the first body and the second body.

13. The hand tool of claim 9, at least one of the first body and the second body further comprising:
a side wall having an outward facing surface; and
a recess defined in the outward facing surface of the side wall;
wherein the pin and the biasing element are positioned within the recess of at least one of the first body and the second body.

14. The hand tool of claim 9, the locking mechanism further comprising:
a second engagement member coupled to a side of at least one of the first jaw and the second jaw opposing the engagement member;
a second pin extending toward the head; and
a second biasing element that engages the second pin, biasing the second pin toward the second engagement member.

15. A multipurpose tool comprising:
a pliers head comprising:
a first jaw; and
a second jaw;
a rotatable first handle, the first handle including a first body and coupled to the first jaw;
a rotatable second handle, the second handle including a second body and coupled to the second jaw;
a plurality of rotatably mounted tool components positioned within the first body of the first handle and the second body of the second handle; and
a locking mechanism configured to secure the first handle with respect to the pliers head, the locking mechanism comprising:
an engagement member coupled to the first jaw, the engagement member including a first projection and a second projection;
a pivot axis extending through the engagement member;
a pin extending toward the pliers head; and
a biasing element that engages the pin, biasing the pin toward the engagement member;
wherein, when the biasing element applies a locking force on the pin, moving the pin into engagement with the engagement member, the first projection resists movement of the pin such that the first handle is secured in an extended position; and
wherein, when the engagement member applies a force greater than the locking force on the pin, the biasing element is compressed such that the pin moves past the first projection into an unlocked position in which the pin is freely rotatable about an outer surface of the engagement member.

16. The multipurpose tool of claim 15, wherein, when the first handle is in the unlocked position, the pin is positioned along the outer surface of the engagement member between the first projection and the second projection.

17. The multipurpose tool of claim 15, wherein, when the first handle is in the unlocked position and rotated toward the pliers head and the engagement member applies a force greater than the locking force on the pin, the pin moves past the second projection such that the first handle is secured in a storage position.

18. The multipurpose tool of claim 17, wherein the pliers head is positioned within the first body when in the storage position.

19. The multipurpose tool of claim 15, further comprising:
a second locking mechanism configured to secure the second handle with respect to the pliers head, the second locking mechanism comprising:
a second engagement member coupled to the second jaw and including a third projection and a fourth projection;
a second pivot axis extending through the second engagement member;
a second pin extending toward the pliers head; and
a second biasing element that engages the second pin, biasing the second pin toward the second engagement member;
wherein the second handle is rotatable about the second pivot axis between a secured position in which the second handle is extended from the second jaw and the unlocked position in which the second pin is freely rotatable about an outer surface of the second engagement member.

20. The multipurpose tool of claim 19, wherein, when the second handle is in the unlocked position and rotated toward the pliers head and the engagement member applies a force greater than the locking force on the second pin, the second pin moves past the fourth projection such that the second handle is secured in a storage position.
